(19) United States
(12) Patent Application Publication
(10) Pub. No.: US 2020/0225258 A1
(43) Pub. Date: Jul. 16, 2020

(54) METHOD AND SYSTEM FOR GENERATING A SIGNAL INDICATING THE ROTATIONAL SPEED OF A DRUM

(71) Applicant: COMMAND ALKON DUTCH TECH B.V., Zoetermeer (NL)

(72) Inventor: Denis BEAUPRE, Sainte-Catherine-de-la-Jacques-Cartier (CA)

(21) Appl. No.: 15/771,502

(22) PCT Filed: Oct. 27, 2016
(86) PCT No.: PCT/EP2016/075917

§ 371 Date: Apr. 27, 2018

Related U.S. Application Data
(60) Provisional application No. 62/247,340, filed on Oct. 28, 2015.
(60) Provisional application No. 62/267,357, filed on Dec. 15, 2015.

(51) Int. Cl. G01P 3/486; G01P 13/04; B28C 5/42; B28C 7/02

(52) U.S. Cl. CPC G01P 3/486; B28C 7/026; B28C 5/422; G01P 13/045

(57) ABSTRACT

The application concerns a system for measuring the rotational speed of a drum rotatably mounted to a mixer truck, rotating relatively to the mixer truck and having a main axis inclined relative to the mixer truck, even in case that the drum is empty. A sensor is mounted to the empty drum and generates a sinusoidal signal as the drum rotates; the sensor could be a load sensor experiencing forces due to the changing influence of gravity during rotation, or a light intensity sensor responsive e.g. to variations of ambient light during rotation. The sensor signal is transmitted over a wireless connection to a receiver. The frequency of the sinusoidal signal is measured and output as the rotational speed of the rotating drum. The application also concerns the determination of a direction of rotation, based on a phase shift between two periodic signals. One signal could be the periodic intensity variation on a first wireless transmission path during a full rotation. The other could be a periodic intensity variation on a second wireless transmission path, or a periodic variation of a sensed value such as the output of a load sensor or light intensity sensor.

### FIELD

The present application relates generally to mixer trucks, and more specifically to methods and systems for use in determining the rotational speed of a rotary drum of a mixer truck.

### BACKGROUND

Mixer trucks have long been used in a variety of industries—most notably the construction industry—for transporting materials from one location to another while maintaining the state of the materials by substantively continuously agitating the contents of a drum of the mixer truck. The motion of the drum may be used to mix and homogenize the materials. Mixer trucks may also be used to combine a plurality of separate materials, which may form a single resultant product: one common example of this involves adding dry cement mix and water to the drum to form ‘ready-mix’ concrete by mixing the cement mix with the water.

It can be useful to measure the rotational speed of the drum of the mixer truck, as this may provide information about a variety of factors, including mixing rate, flow rate, viscosity, and the like. This reading can be useful, for instance when using a probe inside the drum to measure properties of ready-mix concrete such as viscosity, for instance, which requires a measurement of the speed of the drum. Automating the measuring of the rotational speed of the mixer truck in a manner to provide the results in the form of an electromagnetic signal can be relevant for various reasons. For instance, international publication WO 2011/042880 discloses a method to determine rheological properties of concrete in the drum which can use such measurements of drum rotational speed.

This same publication discloses a method of determining the rotational speed of the drum by timing the delay between two substantial increases or decreases in force respectively associated to the penetration of a probe into the concrete, or exit of the probe from the concrete, as an indication of the amount of time it takes for the drum to make a complete revolution. This latter indication can be converted to an angular rotational speed value, for instance. Moreover, by knowing a diameter of the drum at the location of the probe, the latter indication can be converted to a value of the speed of the probe as it travels across the concrete.

Although the aforementioned methods provide some degree of information relating to the rotational speed of the mix drum, there remains room for improvement or alternatives. For instance, the aforementioned methods may be limited to determining the rotational speed of the drum when the drum is at least partially filled with ready-mix concrete.

### SUMMARY

In accordance with an aspect, there is provided a system for measuring a rotational speed of a drum rotatably mounted to a mixer structure and rotating relatively to the mixer structure, comprising: a first transmitter mounted to the rotating drum and a second transmitter stationary relative to the mixer structure; one of the first and second transmitters being configured for transmitting a signal over a wireless connection as the drum rotates; the other one of the first and second transmitters being configured to receive an oscillating signal originating from the signal, the oscillating signal oscillating as the drum rotates such that the oscillating signal has a frequency indicative of the rotational speed of the rotating drum; and a computer having a computer-readable memory having instructions stored thereon that, when executed by a processor, perform the steps of measuring the frequency of the oscillating signal, and outputting the frequency of the oscillating signal as the rotational speed of the rotating drum.

In accordance with another aspect, there is provided a method of measuring a rotational speed of a drum rotatably mounted to a mixer structure and rotating relatively to the mixer structure, using a first transmitter mounted to the rotating drum and a second transmitter being stationary relative to the mixer structure, the first and second transmitters being configured to establish a wireless connection, the method comprising: one of the first and second transmitters transmitting a signal over the wireless connection as the drum rotates; the other one of the first and second transmitters receiving, over the wireless connection, an oscillating signal originating from the signal, the oscillating signal oscillating as the drum rotates such that the oscillating signal has a frequency indicative of the rotational speed of the rotating drum; and using a computer, measuring the frequency of the oscillating signal, and outputting the frequency of the oscillating signal as the rotational speed of the rotating drum.

In accordance with another aspect, there is provided a system for measuring a rotational speed of an empty drum rotatably mounted to a mixer truck, rotating relatively to the mixer truck and having a main axis inclined relative to the mixer truck, the system comprising: a sensor mounted to the empty drum and generating a sinusoidal signal as the empty drum rotates; and a computer having a computer-readable memory having instructions stored thereon that, when executed by a processor, perform the steps of measuring the frequency of the sinusoidal signal, and outputting the frequency of the sinusoidal signal as the rotational speed of the rotating drum.

In accordance with another aspect, there is provided a system for measuring a direction of rotation of a drum rotatably mounted to a mixer structure and rotating relatively to the mixer structure, comprising: a first transmitter mounted to the drum and a second transmitter being stationary relative to the mixer structure; one of the first and second transmitters being configured for transmitting at least one signal over a wireless connection as the drum rotates; the other one of the first and second transmitters being configured to receive first and second oscillating signals originating from the at least one signal, the first and second oscillating signals being neither fully in phase nor fully out of phase relative to one another; and a computer having a computer-readable memory having instructions stored thereon that, when executed by a processor, perform the steps of obtaining calibration data associating one of two opposite directions of rotation of the drum with a reference phase difference; measuring a phase difference between the first and second oscillating signals; and determining that the drum rotates in one of the two opposite directions of rotation by comparing the measured phase difference to the reference phase difference.

In accordance with another aspect, there is provided a method of determining a direction of rotation of a drum rotatably mounted to a mixer structure, using at least a first transmitter mounted to the rotating drum and a second transmitter being stationary relative to the mixer structure, the first and second transmitters being configured to establish a wireless connection, the method comprising: one of the first and second transmitters transmitting at least one signal over a wireless connection as the drum rotates; the other one of the first and second transmitters receiving, over the wireless connection, first and second oscillating signals originating from the at least one signal, the first and second oscillating signals being neither fully in phase nor fully out of phase relative to one another; using a computer, obtaining calibration data associating one of two opposite directions of rotation of the drum with a reference phase difference; measuring a phase difference between the first and second oscillating signals; and determining that the drum rotates in one of the two opposite directions of rotation by comparing the measured phase difference to the reference phase difference.

It will be understood that the expression “computer” as used herein is not to be interpreted in a limiting manner. It is rather used in a broad sense to generally refer to the combination of some form of one or more processing units and some form of memory system accessible by the processing unit(s). A computer can be a network node, a personal computer, a smart phone, an appliance computer, etc.

It will be understood that the various functions of the computer, or more specifically of the processing unit or of the memory controller, can be performed by hardware, by software, or by a combination of both. For example, hardware can include logic gates included as part of a silicon chip of the processor. Software can be in the form of data such as computer-readable instructions stored in the memory system. With respect to a computer, a processing unit, a memory controller, or a processor chip, the expression “configured to” relates to the presence of hardware, software, or a combination of hardware and software which is operable to perform the associated functions.

In accordance with another aspect, there is provided a method of measuring the speed of a rotating drum based on the period of a self-weight imparted force from a force sensor being rotated with the rotating drum.

In accordance with another aspect, there is provided a method of measuring the speed of a rotating drum based on the period of a light-intensity signal emitted by a light-intensity sensor being rotated with the rotating drum.

In accordance with another aspect, there is provided a method of measuring the speed of a rotating drum based on the period of a wireless electromagnetic signal intensity obtained by a corresponding sensor based on a distance between an emitter and a receiver, one of which rotates with the drum, as the drum rotates.

In accordance with another aspect, there is provided a method of determining an angular position of a rotating drum by combining at least two sensor readings, the at least two sensor readings having corresponding maximums and minimums associated to different angular positions of the rotating drum.

In accordance with another aspect, there is provided a method of determining an angular rotation direction of a rotating drum by combining at least two sensor readings, the at least two sensor readings having corresponding maximums and minimums associated to different angular positions of the rotating drum.

In accordance with another aspect, there is provided a method that analyses the history of a signal having a maximum and a minimum value that depend on the drum position to calculate the speed of a rotating drum.

The method can use the signal form one or more load cell mounted on the turning drum and directly connected to a processing unit.

The drum can be a concrete drum and the processing unit can be equipped with a wireless communication device

The method can use the signal from one or more solar panel mounted on the turning drum and directly connected to a processing unit.

The drum can be a drum concrete drum and the processing unit can be equipped with a wireless communication device

In accordance with another aspect, there is provided a method using a radio receiver and processor, mounted on a turning drum, using signal strength of one or more radio transmitter mounted on the support of a turning drum to calculate the speed of the drum.

The drum can be a drum concrete drum and the processing unit can be equipped with a wireless communication device

In accordance with another aspect, there is provided a method using the signal of two or more different sensors giving a signal having a maximum and a minimum value that depend on the drum position and a processing unit to calculate the position of the drum whether the drum is turning or not.

The first oscillating signal can be either:
the load from a load cell mounted on the drum,
the voltage of a solar panel mounted on the drum,
the strength of a radio signal received from an emitter mounted on the drum support,
the strength of a light source mounted on the drum support
the strength of a magnet or electro magnet mounted on the drum support.

One or more other oscillating signals can be either:
the load from a load cell mounted on the drum,
the voltage of a solar panel mounted on the drum,
the strength of a radio signal received from an emitter mounted on the drum support,
the strength of a light source mounted on the drum support
the strength of a magnet or electro magnet mounted on the drum support

The drum can be a drum concrete drum and the processing unit is equipped with a wireless communication device.

In accordance with another aspect, there is provided a method using the signal of two or more different sensors giving a oscillating signal having a maximum and a minimum value that depend on the drum position and a processing unit to calculate the speed and direction of the drum weather it is turning or not.

The first oscillating signal can be either:
the load from a load cell mounted on the drum,
the voltage of a solar panel mounted on the drum,
the strength of a radio signal received from an emitter mounted on the drum support,
the strength of a light source mounted on the drum support
the strength of a magnet or electro magnet mounted on the drum support.

One or more other oscillating signals can be either:
the load from a load cell mounted on the drum,
the voltage of a solar panel mounted on the drum,
the strength of a radio signal received from an emitter mounted on the drum support,
the strength of a light source mounted on the drum support
the strength of a magnet or electro magnet mounted on the drum support

The drum can be a drum concrete drum and the processing unit is equipped with a wireless communication device.

In accordance with another aspect, there is provided a method to determine the direction and speed of a rotating drum equipped with a radio module and mounted on a ready-mix truck parked under a loading point where the loading point is equipped with two radio modules linked to a processor unit were the strength of the radio signal from the radio unit is used to determine at least two successive rotating angle of the drum to determine the speed and direction of the rotating drum.

In accordance with another aspect, there is provided a method to determine the direction and speed of a rotating drum equipped with a radio module and mounted on a ready-mix truck parked under a loading point where the loading point is equipped with two radio modules linked to a processor unit were the strength of the radio signal from the two fixed radio unit is used to determine at least two successive rotating angle of the drum to determine the speed and direction of the rotating drum and where rotational status of the drum is relayed wirelessly to the batching plant.

In accordance with another aspect, there is provided a method where the direction and speed of the rotating drum is used to prevent the opening of the gate of the loading hopper or mixer of a batching plant in order to avoid spillage of the material being loaded in the drum.

In accordance with a further aspect, there is provided a mixer truck. The mixer truck comprises a drum attached to the mixer truck, positioned at an angle and comprising an inner wall and an outer surface; at least one sensor attached to the drum, each configured for collecting respective sensor data and for relaying a respective signal comprising the respective sensor data over a wireless connection; and a computing unit configured for obtaining the sensor data, the computing unit comprising a processor configured for processing the sensor data to determine at least one of a speed of rotation and a direction of rotation of the drum.

In accordance with a further aspect, there is provided a method of measuring a speed of a rotation of a drum of a mixer truck. The method comprises acquiring sensor data from a sensor located on the drum; transmitting the sensor data to a processing unit; and determining a period of the sensor data.

Many further features and combinations thereof concerning the present improvements will appear to those skilled in the art following a reading of the instant disclosure.

### BRIEF DESCRIPTION OF THE DRAWINGS

In the figures,

FIG. 1 is an elevation side view of an example of a concrete mixer truck having an empty drum;

FIG. 2 is a partial sectional view taken along line 2-2 of FIG. 1;

FIG. 3 is a cross-sectional view of an empty drum, showing a probe at four angular positions;

FIG. 4 is a graph showing load values as a function of time for two different rotational speeds of the empty drum;

FIG. 5 is a schematic view of an example of a computer;

FIG. 6 shows the variation of force reading at four angular positions;

FIG. 7 is a graphical illustration in polar coordinates of the strength of a signal from a solar panel attached to the drum while drum is turning;

FIG. 8 is a graphical illustration in polar coordinates of the strength of a radio signal from a radio-transmitter display unit at different angles;

FIG. 9 is a graphical illustration of a system using two radio transmitters to measure the position of a sensor and other parameters;

FIG. 10 is a graphical illustration of a system using two radio receivers to measure the position of a transmitter and other parameters (polar coordinates);

FIG. 11 is a graphical illustration of a system using two radio receivers mounted on a batching plant and one radio mounted on the drum of the truck;

FIG. 12A is a graph showing two sinusoidal signals indicative that the empty drum rotates in a first direction of rotation;

FIG. 12B is a graph showing two sinusoidal signals indicative that the empty drum rotates in a second direction of rotation; and

FIG. 13 is a graph showing two sinusoidal signals indicative that the empty drum rotates in a first direction of rotation and then in a second direction of rotation.

### DETAILED DESCRIPTION

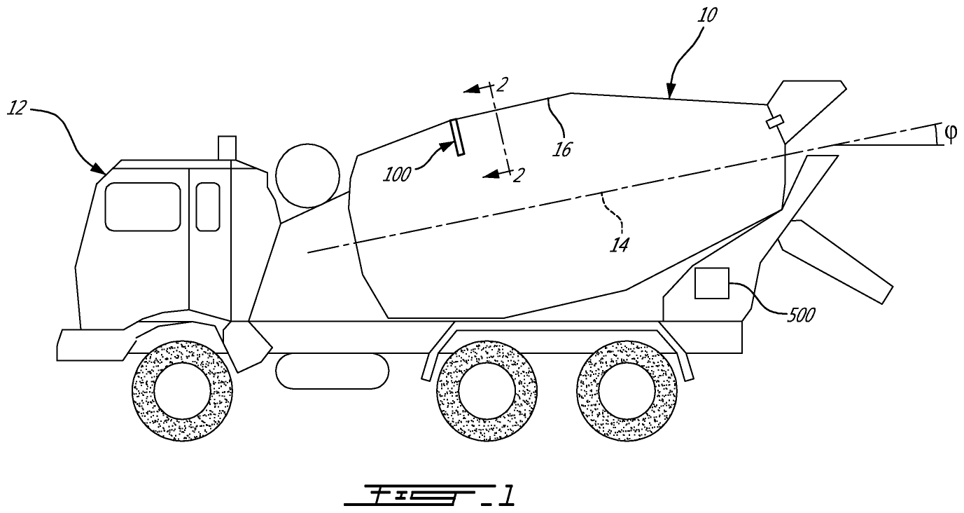

Reference is made to FIG. 1, in which a mixer structure such as a mixer truck 12 is illustrated. As depicted, the mixer truck 12 has a drum 10 with an inner wall 16. The drum 10 is rotatably mounted to the mixer truck 12, such that it is able to rotate about a main axis 14 of the drum 10 to extend the life of fresh concrete therein prior to solidification. The main axis 14 of the mixer truck 12 is generally inclined relative to the vertical and forms an inclination angle φ with the horizon.

Additionally, the mixer truck 12 is provided with a probe 100 which may generate an electromagnetic signal indicative of a force applied by wet concrete in the drum 10 onto the probe as the probe is moved in the ready-mix concrete during rotation of the drum 10. The probe 100 may be any suitable probe 100, such as the probe described in International Patent Application Publication Number WO 2011/042880. The probe 100, as shown in FIG. 1, is mounted on the inner wall 16 of the drum 10 of the mixer truck 12.

With continued reference to FIG. 1, the probe 100 is shown schematically as being inside the drum 10 and may be configured to obtain indications of rheological properties during use of the mixer truck 12, i.e. when the drum 10 is filled with fresh concrete. When the probe 100 is immersed in fresh concrete, the probe 100 is configured to obtain a variety of data relating to various rheological properties; for instance, the probe 100 may obtain indications of rotational speed and direction, fluid flow properties, fluid temperature, and the like.

The probe 100 may also be configured to be used to determine the rotational speed of the rotating drum even when the drum 10 is empty. In this disclosure, the expression “empty drum” is to be construed broadly so as to encompass situations where, even though the drum has a volume of substance therein, the drum is empty enough to avoid interference between the probe 100 and any substance therein. For instance, the empty drum can be either completely empty or nearly empty. More specifically, the following describes an example of a method and an associated system for measuring the rotational speed of the empty drum 10, which was found to be convenient in some circumstances.

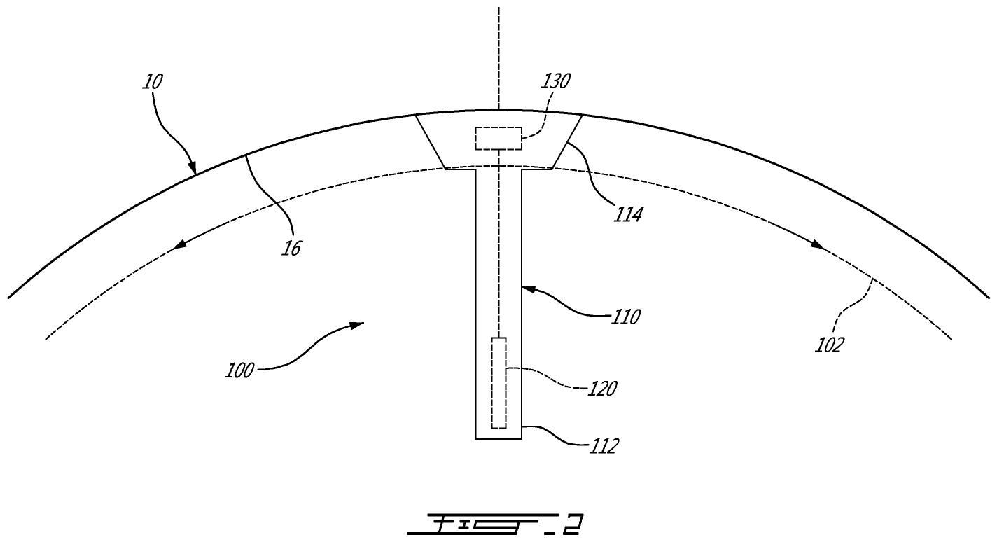

Prior to going into the details of the method, the probe 100 is described shortly with reference to FIG. 2. FIG. 2 is a partial sectional view taken along section 2-2 shown in FIG. 1. The probe 100 may be mounted to an inner wall 16 of the empty drum 10. During rotation of the empty drum 10 about the main axis 14, the probe 100 may move along a circular path 102. As will be described below in further detail, the measurement of the rotational speed of the drum 10 may be based on load value measured by the probe 100 as it is moved along the circular path 102 when the drum 10 is empty. The rotation of the drum 10 may be one of two directions of rotation, i.e. clockwise or counter-clockwise.

As shown, the probe 100 may have a cantilevered body 110 having a free end 112 and a fixed end 114 which is mounted to the inner wall 16. The free end 112 of the cantilevered body 110 may extend radially inwardly from the inner wall 16 of the empty drum 10. In alternate embodiments, the free end 112 may extend inwardly but not necessarily radially in the empty drum 10. As shown, the probe 100 has at least one load cell 120 (referred to as “the load cell 120” herein) secured along the free end 112 of the body 110. The load cell 120 may be used to provide a load value proportional to a force which is tangential to the circular path 102 (referred to herein as “tangential force”). In other words, in the probe 100, the load cell 120 may be used to provide a load value associated with the fresh concrete which exerts a force on the cantilevered body 110 of the probe 100. Additionally, the load cell 120 may be further used to provide a load value associated with the gravity which exerts a force of the cantilevered body 110 of the probe 100 when the probe is not oriented in a vertical orientation.

With further reference to FIG. 2, as discussed above, the probe 100 may be attached to the inner wall 16 of the mixer drum 10 of the mixer truck 12 (see FIG. 1) and may extend radially therefrom. While only the probe 100 is shown, it should be noted that the mixer truck 12 may comprise any number of sensors, including the probe 100. Any signal from sensors mounted on a ready-mix drum 10 can be transmitted, using a transmitter, to another suitable receiver, which may be mounted on the mixer truck 12, using any suitable wireless transmission protocol such as Bluetooth, Bitlbee, WiFi (of any suitable band, such as a/b/g/n/ac/an and the like), or any other appropriate wireless transmission protocol. Alternatively, or in addition, the sensors, including the probe 100, may be configured to communicate with the receiver which may not be mounted on the mixer truck 12, but may be held by an operator of the mixer truck 12, or may be disposed elsewhere in the vicinity of the mixer truck 12 and within transmission range from the probe 100 and any other sensors. Alternatively still, or also in addition, the sensors may be configured to communicate over cellular networks with remote receivers, using any suitable technology such as 3G, 4G, 5G, HSPA, HSPA+, GSM, EDGE, and the like. It will be noted that positioning the load cell 120 closer to the free end 112 of the cantilevered body 110 may contribute in increasing the leverage so that requirements of the load cell 120 can be lowered. It will be understood that the load value associated with a force due to gravity is weaker than the load value associated with a force due to fresh concrete and that therefore the load cell 120 can be provided with a satisfactory degree of precision to allow distinguishing forces exerted by gravity from any noise.

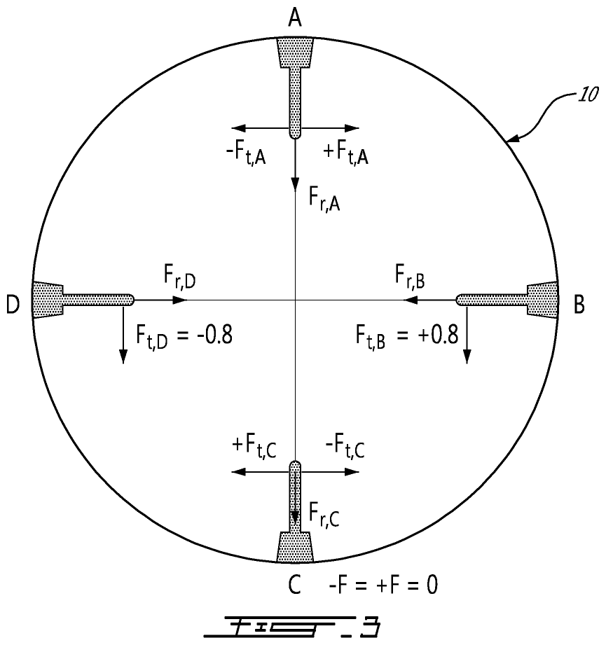

With reference to FIG. 3, there is shown exemplary tangential forces that can be applied by gravity on the cantilevered body 110 of the probe 100. For instance, when the probe 100 is immobile in an empty drum 10, at circumferential positions A and C (position A corresponds to the position of the probe 100 shown in FIG. 1), gravity may exert strictly radial forces F_{r,A}, F_{r,C} on the probe 100 such that tangential forces F_{t,A}, F_{t,C} may be null. Accordingly, the load cell 120 which may be adapted to measure tangential forces provides a reading of 0. However, the inverse may be observed when the probe 100 is at circumferential positions B and D, wherein the gravity may exert strictly tangential forces F_{t,B}, F_{t,D} on the probe 100 such that radial forces F_{r,B}, F_{r,D} may be null. At all times, the load cell 120 may be configured to provide a load value associated with the tangential forces that the gravity exerts on the probe 100 due to the weight of the probe, and the actual load value may therefore depend on the circumferential position of the probe 100 along the circular path 102. Accordingly, and as will be discussed below, even if the probe 100 may be designed to be used while being immersed in fresh concrete, the probe 100 may also be used when the drum 10 is empty.

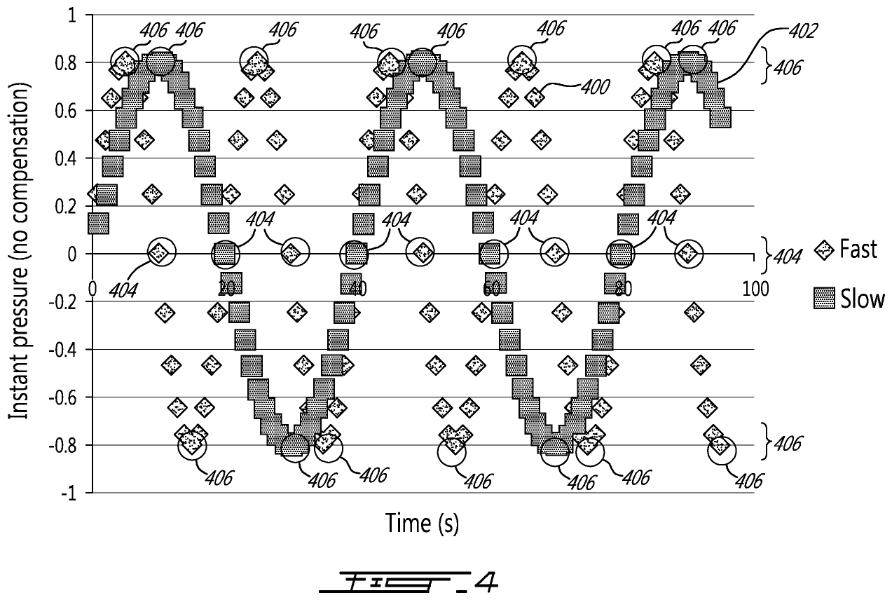

FIG. 4 shows examples of oscillating signals such as sinusoidal signals provided in the form of tangential load value series 400, 402 measured by the load cell 120 of the probe 100 as the empty drum 10 is rotated respectively at a first rotational speed and at a second rotational speed, faster than the first rotational speed. The sinusoidal load value series 400, 402 comprise load value data which may be collected by the probe 100, or any other suitable sensors, and are typically sinusoidal-like when the drum 10 is empty. Accordingly, each of the tangential load value series 400, 402 have extreme tangential load values such as minimal tangential load values 404 (when the probe 100 is at positions A and C) and maximal tangential load values 406 (when the probe 100 is at positions B and D).

The amount of time elapsed between the extremes may be proportional to the amount of time elapsed during a single drum rotation and may thus be used to determine a measure of number of drum rotations/time unit, which may be expressed as a value of revolutions per minute (RPM), for instance. Accordingly, the probe 100 may be configured to generate an electromagnetic signal indicative of measured value of the rotational speed of the empty drum 10.

While the use of a wired connection to acquire information from the probe 100 (and from any further sensors) is also considered, due to the rotational motion of the drum 10 there is a certain challenge in bringing a wired connection inside a rotary container such as the drum 10. As such, and referring back to FIG. 2, the probe 100 can be equipped with a transmitter 130 that can transmit the sinusoidal signal (e.g., in the form of sinusoidal load value data or series of values) received from the load cell 120 to a computer 500 via a wireless connection. This transmitter can be self-powered (i.e. via a battery), or may draw power from the mixer truck 12, for example via a rotational connector, via an induction charger, or via any other suitable method.

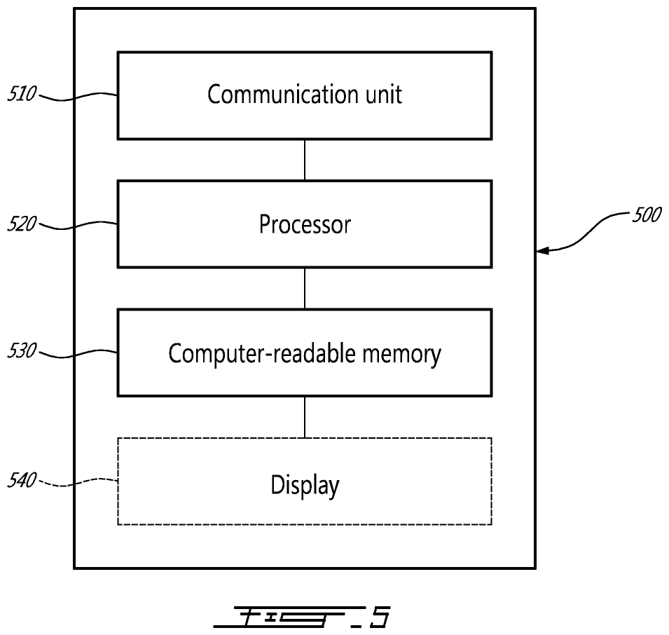

With reference to FIG. 5, the receiver may be comprised in a computer 500, which in turn may comprise a communication unit 510 such as an antenna for receiving or transmitting a wired or wireless transmission of an electromagnetic signal from the probe 100 or from any other suitable sensor, a processor 520, and a computer-readable memory 530 for storing at least the sinusoidal load value data. In certain embodiments, the receiver, or the computer 500, may have a display 540 for displaying the instantaneous rotational speed of the empty drum 10 so as to make the instantaneous rotational speed of the empty drum 10 available to a driver of the mixer truck. In some further embodiments, the sinusoidal load value data can be transmitted wirelessly, and optionally via the Internet, and the computer 500 may be located at a distant location. In still further embodiments, the computer 500 may be provided as part of the probe 100.

It is to be understood that the meaning of the term “instantaneous” as used in this disclosure is meant to encompass delays due to transmission of the data, computation and/or averaging of the data in order to provide results being statistically meaningful. In the embodiment shown in FIG. 1, for instance, the computer 500 may be mounted to the mixer truck 12 and may display the instantaneous rotational speed of the empty drum 10 to an operator of the mixer truck 12. Although only a certain amount of components of the computer 500 is described, it is to be appreciated that the computer 500 may comprise other components that can be used for other purposes. For instance, the computer 500 may be provided as part of the probe 100 and the computer-implemented measure of rotational speed can be provided within the housing of the probe 100.

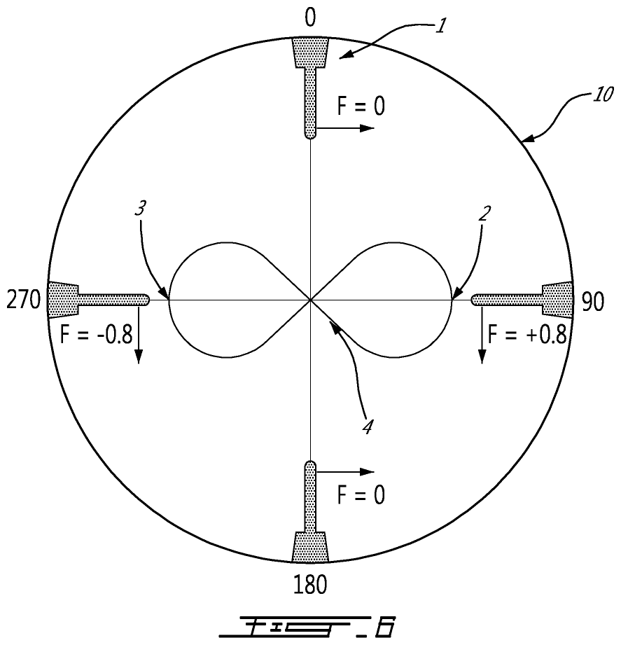

With reference to FIG. 6, the force which may be exerted on the probe 100 at various positions (marked in polar coordinates) is shown. In accordance with a first example of the aforementioned method, the probe may be first positioned to be in top position (reference position=0 degree). When in top position, and the drum 10 is empty, the load sensor may not measure any forces (F=0). If the drum 10 is rotated to the right position (angle=90 degrees), the self-weight of the sensor may create a positive force on it. The force may be expressed as a pressure by dividing the force on the load cell by the projected surface of the probe's outer tube. To provide an illustrative example, the self-weight of the probe 100 when in the horizontal orientation may cause the probe 100 to detect a pressure in the order of 1 kPa, for instance, though other embodiments may cause different pressures to be sensed by the probe 100.

When rotated to the left position (angle=270 degrees) the pressure may be measured as negative and may be equal to −0.8 kPa when the drum 10 is empty. The maximum positive (2) and minimum pressure (3) from the self-weight of the sensor may be represented by the pressure pattern (4) shown in FIG. 6. The probe is designed and built in such a way that it rotates along the circular path and that the cantilevered body exerts a minimal gravitationally self-imparted force on the load sensor at two circumferentially spaced-apart positions around the circular path. For instance, in this embodiment, when in top and bottom positions (0 degree and 180 degrees), the pressure measured by the probe may be equal to zero.

When turning, pressure measured by the sensor follows a sinusoidal pattern with maximum and minimum value close to +/−0.8 kPa, which may be similar to the sinusoidal pattern illustrated in FIG. 4. By measuring the time to move from a minimum pressure (at 0° and 180°) to a maximum pressure (at 90° and 270°), from one minimum or maximum to the other (e.g. 0° to 180° or 90° to 270°), or to return to the same maximum or minimum pressure values, it may be possible to calculate the speed of the drum 10 while turning. This may be performed by linking the probe 100 to a processor, which may be the processor 520 of the receiver, or may be a processor associated with the probe 100. In the latter case, the results can be sent to the receiving by any of the aforementioned wireless communication protocols or systems.

Referring back to the graph of FIG. 4, in this specific example, the “Fast” speed has a period of 22 seconds between two successive maximum or two successive minimum pressure. This represents a speed of 60/22=2.72 rotations per minute (rpm). The “Slow” speed has a period of 44 seconds and thus a speed of 60/44=1.36 rpm. It may also be possible to calculate the speed by using the time between a minimum and the following maximum pressure, or vice versa.

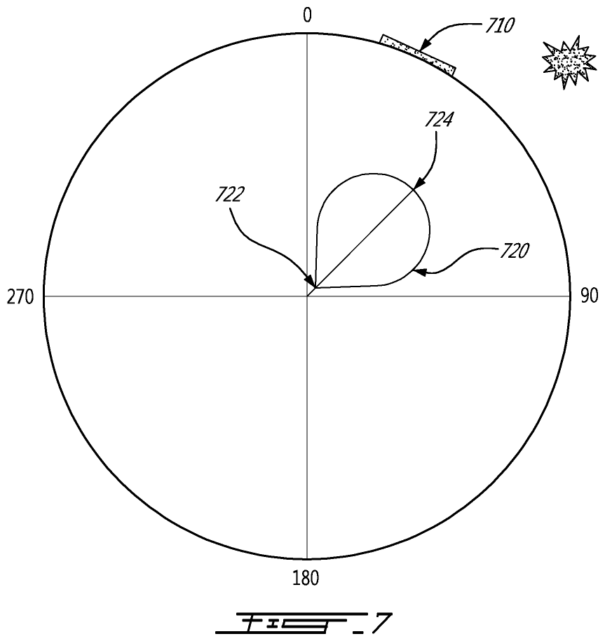

With reference to FIG. 7, another example method to determine a rotational speed of the drum 10 will now be described. In this example, the mixer truck 12 is provided with a light intensity sensor 710, which may be located on an outer surface of the drum 10, and which may be, for example, a solar panel. The light intensity sensor 710 may be configured for detecting the intensity of ambient light in the environment surrounding the mixer truck 12 during the rotation of the drum 10. For instance, during day time (i.e. when the sun is visible in the environment surrounding the mixer truck 12), the light intensity sensor 710 may cause power to be generated by being exposed to ambient sunlight. In generating this power, the light intensity sensor 710 attached to the drum 10 may also generate an oscillating signal 720 which may vary with the intensity of the light to which the light intensity sensor 710 is exposed: for example, this oscillating signal may be the current generated by the light intensity sensor 710. As such, in a given situation the oscillating signal 720 may have a minimum value 722 and a maximum value 724 that can be used to determine the speed of the rotating drum 10. A processor attached to the light intensity sensor 710 may be used to calculate the speed of the drum 10 using the process described hereinabove and send it to the receiver using any of the aforementioned wireless communication protocols or systems.

To determine the speed of rotation of the drum 10, the processor may also rely on further information to make inferences about the environment surrounding the mixer truck 12. For example, by using GPS information (which may be available to the processor and/or to the receiver) as well as known sunrise and sunset times, it may be possible to determine where, relative to the mixer truck 12, and more specifically relative to the light intensity sensor 710, where the sun is located, which may allow for more precise calculations for determining the rotational speed of the drum 10. Additionally, while the foregoing discussion has related to using sunlight intensity to determine the rotational speed of the drum 10, it should be noted that in indoor environments, or when the sun is not visible (i.e., in cloudy conditions or at night), it may nevertheless be possible to use the light intensity sensor 710 to determine the rotational speed of the drum 10. For example, the light intensity sensor 710 and the associated processor may be configured for collecting light intensity data and for analyzing the collected light intensity data to notice patterns in the light intensity data, which may allow the processor to determine the rotational speed of the drum 10.

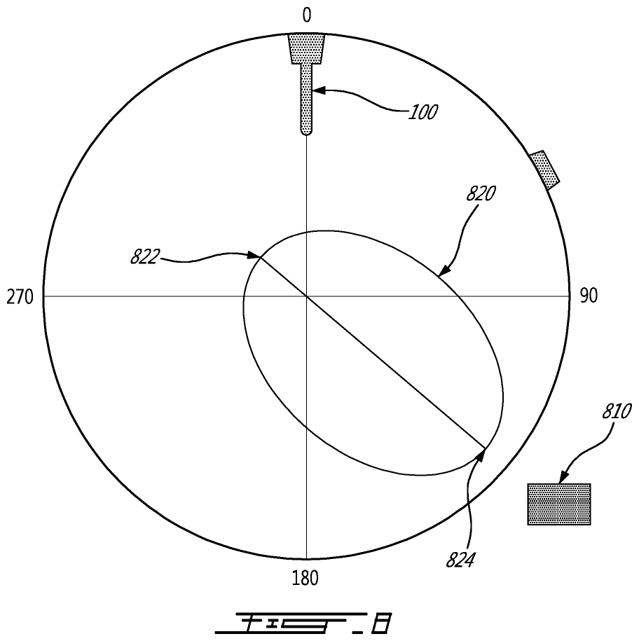

With reference to FIG. 8, another example method to determine rotational speed of the drum 10 will now be described. In this example, the method is based on the varying value of wireless transmission signal strength between the probe 100 and the receiver, and more specifically the computer 500.

Indeed, as discussed supra, the probe 100 can include a processor and a wireless receiver/transmitter adapted to exchange information, for example via electromagnetic signaling, wirelessly between the probe 100 and an external device (such as the aforementioned receiver or any other transmitter) which can be fixedly attached relative to a frame of the mixer truck. The wireless electromagnetic signal may be radio waves, for instance, or any other suitable signal for transmitting information. In an exemplary embodiment of a system implementing this method, the system shown in FIG. 8 also includes a computer 810, which may be similar to the computer 500, and which may have a display and a similar wireless transmitter/receiver. The probe 100 may be programmed to send at least one radio signal at predetermined time intervals. The time intervals may be regular (i.e. periodic), or may be irregular, such as based on triggers (from the computer 500 or the probe 100), or following any other suitable logic. The strength of the signal received by the receiver has different strength level depending on its relative position with the transmitter. When the probe 100 is located in relatively close proximity to the receiver, the strength of the radio signal may be proportionately stronger; conversely, when the probe 100 is located relatively far from the receiver, the strength of the radio signal may be proportionately weaker. The strength pattern of the radio signal 820 can be evaluated by the computer 810. Again, the pattern is sinusoidal and includes a minimum signal strength value 822 when the sensor 100 is on the opposite side of the computer 810 unit and a maximum strength value 824 when the sensor 100 is at the closest to the computer 810. In an alternate embodiment, the roles of the probe 100 and of the computer 810 can be interchanged. For instance, the probe 100 can be adapted to measure the variations between successive signals received from a transmitter of the computer 810 and can be provided with its own processor to calculate the speed of the drum 10 using the process described above. The measured rotational speed value data can be used by the probe 100 or transmitted by the probe unit via a wired or wireless electromagnetic signal to any other suitable element of the mixer truck 12.

Thus, the present application considers the use of the at least one sinusoidal signal from the solar panel or the strength of the radio signal to calculate the speed of rotating drum 10. Each of the methods described herein may allow for calculating the rotational speed of a rotating device based on a sinusoidal, or otherwise periodic, signal variation, though in certain embodiments it may be possible to determine the speed of a rotating device based on other signal variation patterns.

In a further aspect, it may be possible to double any one (or more) of the systems referred to above, or to combine two or more of the methods described above. Double readings can be used to obtain redundancy of speed measurement, for instance, or may be used to determine the rotational speed more quickly. Moreover, double readings which may have different maximum and minimum locations may be used to further determine the position of the probe 100 along its rotary path, for instance. In particular, oscillating signals or any two or more signals, whether from different types of sensors or from the same types of sensors, that may have a maximum and minimum value may be used to determine the angle of the sensor, the drum speed, the drum rotation direction and/or the number of turns form an initial position, provided the received signal(s) do not have common positions for their respective maximum and the minimum values. These values may then be sent back to a unit fixed on the mixer truck 12 using wireless communication, and may be processed by said fixed unit; alternatively, the values may be processed by the probe 100, and the resulting data can be used or transmitted by the probe 100.

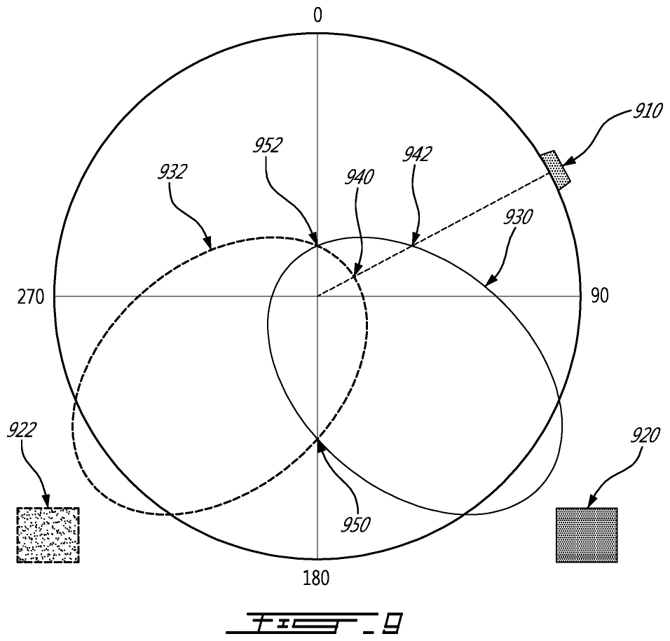

With reference to FIG. 9, an example embodiment comprises one radio receiver 910 with two different radio transmitters 920, 922 mounted on two different portions (i.e. in different locations) of the mixer truck 12 which supports the drum 10. When the drum 10 is turning, the receiver 910 may receive two radio signals, each of which may create a different oscillating signal strength variation pattern: right transmitter 920 may create pattern 930 while left transmitter 922 creates pattern 932. Each of the patterns 930, 932 may have different positions for their maximum and minimum radio signal strength. As such, for any given position of the radio receiver 910, there may exist a corresponding unique (or substantially unique) combination of values from both transmitters. For example, when the receiver 910 is in a position as illustrated in FIG. 9, there are values 920 from left transmitter 922 and value 942 from right transmitter 920. The radio receiver 910 may be linked with a processor that may be capable of self-acquiring the patterns from both transmitter 920, 922 and record them. A reference position, which may be the top (0°), may be defined as the position where the signal strength from both transmitters 920, 922 is equal. There may be two such positions (as in this case, positions 950 and 952) but the one with the lowest equal values may be chosen to be the reference position; alternatively, the reference position may be set as the position with the highest equal values. It is also possible to manually send a signal when the operator places the radio receiver in the lowest or top position. This method does not require the mixer drum 10 to turn to measure position: the position can be determined statically or dynamically. Once the mixer drum 10 begins moving and the direction is determined, only one transmitter 920, 922 may be required and the other transmitter 920, 922 may be switched off to save power until a new position determination is required.

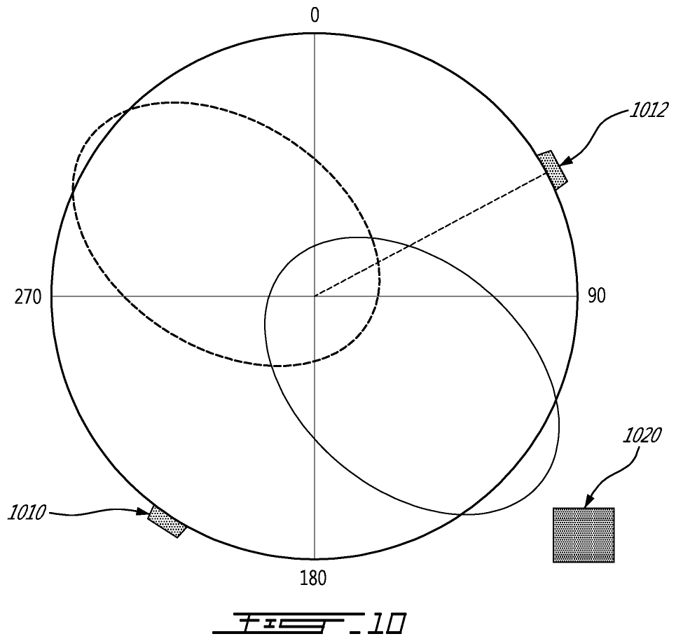

With reference to FIG. 10, another example method, corollary to the embodiment presented supra in FIG. 9, is to use a single transmitter 1020 and two radio receivers (1010 and 1012) mounted on the rotating drum 10 as shown in FIG. 10.

When the speed of the drum 10 is calculated and provided to the operator of the mixer truck 12, for example via the display 540 of the computing unit 500, the computing unit 500 may be configured to further process the information provided to count a number of turns of the drum 10 since a given event, such as a start point of a mixing operation or a start point of an unloading operation (when the direction of rotation of the drum 10 is reversed by the driver of the mixer truck 12).

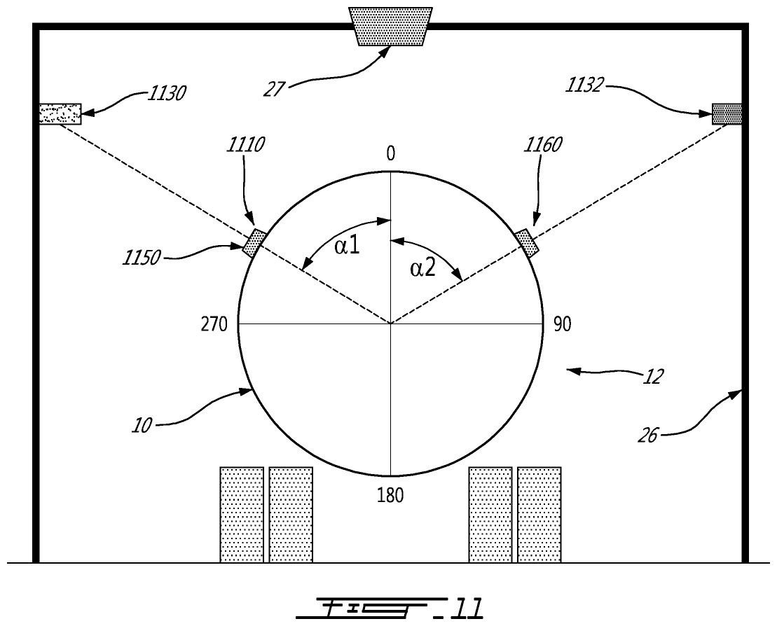

With reference to FIG. 11, another aspect comprises a ready-mix truck 12 which may be parked for loading under a batching plant 26 equipped with a hopper 27. The drum 10 of the ready-mix truck 12 may rotate in a particular angular direction to avoid spillage of material being loaded. This direction of rotation may be clockwise or counter-clockwise depending on the truck 12; while the particular direction of rotation for a given mixer truck 12 may not be crucial, it should be noted that each mixer truck 12 will rotate in a given direction for to maintain the material within the drum 10. In certain embodiments, the drum 10 may be equipped with at least one radio transmitter 1100 mounted on the drum 10. The batching plant 26 may be equipped with at least one radio transmitter: in this embodiment, two radio transmitters 1130 and 1132 are provided, with at least one of them linked, by radio or by any other suitable way, to a processor, which may be located locally within the batching plant 26, on or within the mixer truck 12, or in any other suitable location. The radio transmitter 1110 mounted on the drum 10 may transmit a radio signal on regular basis, which may be obtained by the two fixed radio transmitters 1130 and 1132. The radio signal transmitted by the radio transmitter 1110 may be directed at each of the fixed radio transmitters 1130, 1132, or may be unidirectional and merely intercepted by the fixed radio transmitters 1130, 1132. Each fixed radio transmitter 1130 and 1132 may be configured for evaluating the strength of the radio signal transmitted by the radio transmitter 1110. The radio signal transmitted by the radio transmitter 1110 has an oscillating form, and may exhibit a respective maximum strength at a respective specific position (angle α1 at position 1150 and angle α2 at position 1160) for each of the fixed radio transmitters 1130, 1132 (which may be determined by the radio module itself). Specifically, the maximum strength for radio module 1130 may be when the rotating radio transmitter 1110 occupies position 1150, or with an angle of α1; and the maximum strength for radio transmitter 1132 may be when the rotating radio transmitter 1100 occupies position 1160, or with an angle of α2. The processor may use the time at which the rotating radio transmitter 1110 was in position 1150 and 1160 and the value of α1 and α2 to determine the rotational speed and direction of rotation of the drum 10. When the direction of rotation of the drum is known, this information can be sent to a control unit (not pictured) of the batching plant 26, and the control unit may make a decision relating to whether to open the gate of the hopper 27 holding the material to be loaded into the drum 10 of the mixer truck 12.

In a further embodiment, the fixed radio transmitters 1130 and 1132 may send, on a regular, semi-regular, or irregular basis, a radio signal to the rotating radio transmitter 1110 which is provided with a processing unit. Similarly to the above, the strength of the radio signal received by the rotating radio transmitter 1110 has an oscillating form, and each signal may exhibit a maximum strength when the rotating radio transmitter 1110 is positioned at a respective specific position for each respective fixed radio transmitter 1130, 1132, namely α1 for radio transmitter 1130 and α2 for radio transmitter 1132. The rotating radio transmitter and associated processing unit may then determine, based on the signals received and the position of the fixed radio transmitters 1130, 1132, the direction and speed of rotation of the drum 10. The information acquired in this fashion may then be sent wirelessly to the control system of the batching plant 26, as expressed above.

In any of the embodiments discussed hereinabove which make use of the signal strength of a transmitter to determine the rotational speed or direction of the drum 10, or any other information relating the drum 10, the signal in question may provide an indication of an identifier of the transmitter, so that the receiver of the system in question can differentiate between different transmitters.

In another aspect, there is described a system for measuring a rotational speed of a drum rotatably mounted to a mixer structure and rotating relatively to the mixer structure. The mixer structure can be provided in the form of a mixer truck, a batching plant or any other suitable mixer structure.

Broadly described, the system generally has a first transmitter mounted to the rotating drum and a second transmitter stationary relative to the mixer structure. One of the first and second transmitters is configured for transmitting a signal over a wireless connection as the drum rotates whereas the other one of the first and second transmitters is configured to receive an oscillating signal originating from the signal. The signal can be an analog signal or a digital signal carrying signal data. The oscillating signal, or equivalently the signal data of the oscillating signal, oscillates as the drum rotates such that it has a frequency indicative of the rotational speed of the rotating drum. The system has a computer having a computer-readable memory having instructions stored thereon that, when executed by a processor, perform the steps of measuring the frequency of the oscillating signal, and outputting the frequency of the oscillating signal as the rotational speed of the rotating drum. The rotational speed of the rotating drum can be displayed to a user where appropriate or stored on a computer-readable memory for subsequent analysis or consultation.

In some embodiments, the oscillating signal corresponds to a strength of the signal transmitted by the one of the first and second transmitters. The strength of the signal can thus oscillate as function of a varying distance between the first and second transmitters when the drum rotates. Indeed, the signal needs not be sinusoidal per se. However, the second transmitter receives the signal and finds the oscillating signal in a strength of the electromagnetic signal as transmitted by the one of the first and second transmitters since the first transmitter rotates with the rotating drum. The varying distance and physical obstruction between the first and second transmitters can cause the variability and periodicity in the strength of the signal. It can therefore be said that the oscillating signal originates from the signal transmitted by the one of the first and second signals.

In some other embodiments, the one of the first and second transmitters is configured to transmit the signal with a unique identifier of the one of the first and second transmitted. Accordingly, the other one of the first and second transmitters can recognize the oscillating signal as per the presence of the unique identifier in the signal.

As can be understood from the embodiments described above, in alternate embodiments, the system has a sensor which is mounted to the rotating drum and which has a wired connection to the first transmitter. In this way, the sensor can transmit the oscillating signal to the first transmitter via the wired connection. Accordingly, the signal which is transmitted by the one of the first and second transmitter is the oscillating signal in these embodiments.

It is intended that in embodiments wherein the mixer structure is a mixer truck wherein the rotating drum has a main axis inclined relative to the mixer truck, the sensor can be a load sensor as described above. The load sensor can have a cantilevered body inwardly projecting from an inner wall of the rotating drum such that the oscillating signal is indicative of a force exerted on the load sensor as the drum rotates. These embodiments can even be used when the drum is empty. For instance, in cases where the drum is empty, the oscillating signal is a sinusoidal signal indicative of a gravitationally self-imparted force exerted on the load sensor as the drum rotates.

It is also intended that in embodiments wherein the mixer structure is a mixer truck wherein the rotating drum has a main axis inclined relative to the mixer truck, the sensor can be a light-intensity sensor as described above. The light-intensity sensor can be located on an outer wall of the rotating drum in a manner that the oscillating signal is indicative of an intensity of light shining on the light-intensity sensor as the drum rotates.

In another aspect, a method associated with the system described in the preceding paragraphs is also described. For instance, a method of measuring a rotational speed of a drum rotatably mounted to a mixer structure and rotating relatively to the mixer structure is described. This method uses a first transmitter mounted to the rotating drum and a second transmitter being stationary relative to the mixer structure wherein the first and second transmitters are configured to establish a wireless connection with one another. The method generally has the steps of transmitting a signal over the wireless connection as the drum rotates. A step of receiving, over the wireless connection, an oscillating signal originating from the signal. The oscillating signal can thus oscillate as the drum rotates such that it can have a frequency indicative of the rotational speed of the rotating drum. Some steps are computer-implemented to measure the frequency of the oscillating signal, and to output the frequency of the oscillating signal as the rotational speed of the rotating drum. The steps can include a step of displaying the rotational speed of the rotating drum on a display.

In some embodiments, the method has a step of generating the oscillating signal using a sensor mounted to the rotating drum and having a wired connection to the first transmitter. A step of transmitting the oscillating signal to the first transmitter is also provided in these embodiments such that the signal transmitted by the one of the first and second transmitter is the oscillating signal.

As will be understood, as per the nature of the one of the first and second transmitters, the oscillating signal can be periodic (triangle function, square function and the like) or sinusoidal (the term “sinusoidal” is used interchangeably with the term “cosinusoidal” and other known oscillating functions).

In some embodiments, the step of measuring the frequency includes a step of matching (as in “fitting”) an oscillating function (i.e. a mathematical function) on a previously received portion of the oscillating signal and a step of associating a frequency of the oscillating function as the frequency of the oscillating signal. In these embodiments, the previously received portion can extend along a period of time suitable for matching of a fitting function thereon. For instance, the previously received portion can extend along a half cycle, a full cycle, more than one cycle of the oscillating signal.

In some other embodiments, the step of measuring the frequency includes a step of identifying at least two reference points in the previously received portion of the oscillating signal and a step of calculating the frequency of the oscillating signal based on a time duration between the at least two reference points. For instance, as can be understood, when the previously received portion of the oscillating signal includes at least one cycle of the oscillating signal, the at least two reference points can be two successive extremes (e.g., maxima) of the oscillating signal.

In alternate embodiments, the step of measuring the frequency includes a step of differentiating the previously received portion of the oscillating signal and a step of associating a frequency of the derivative of the previously received portion of the oscillating signal as the frequency of the oscillating signal. In these embodiments, the differentiation was found useful because it can help reduce the impact of biased values since the differentiation acts as a filter on the oscillating signal. The output rotational speed can thus have an increased precision compared to embodiments where the step of differentiating is omitted.

As can be understood from the description above, the computer can be configured to, upon obtaining at least one of an angular position and a direction of rotation of the rotating drum at a given time, track the at least one of the angular position and the direction of rotation of the rotating drum as function of time based on the oscillating signal.

In another aspect, there is described a system for measuring a rotational speed of an empty drum rotatably mounted to a mixer truck. In this system the empty drum rotates relatively to the mixer truck and as a main axis inclined relative to the mixer truck. Broadly described, the system generally has a sensor mounted to the empty drum and which generates a sinusoidal signal as the empty drum rotates and a computer having a computer-readable memory having instructions stored thereon that, when executed by a processor, perform the steps of measuring the frequency of the sinusoidal signal, and outputting the frequency of the sinusoidal signal as the rotational speed of the rotating drum.

In some embodiments, the sensor is a load sensor having a cantilevered body inwardly projecting from an inner wall of the empty drum such that the sinusoidal signal is indicative of a gravitationally self-imparted force exerted on the load sensor as the empty drum rotates.

In some other embodiments, the sensor is a light-intensity sensor located on an outer wall of the rotating drum such that the oscillating signal is indicative of an intensity of light shining on the light-intensity sensor as the drum rotates.

In still another aspect, a system for measuring a direction of rotation of a drum rotatably mounted to a mixer structure and rotating relatively to the mixer structure is described. As mentioned above, the mixer structure can be a mixer truck, a batching plant and the like. Generally put, the system has a first transmitter mounted to the drum and a second transmitter being stationary relative to the mixer structure. One of the first and second transmitters is configured for transmitting at least one signal over a wireless connection as the drum rotates whereas the other one of the first and second transmitters being configured to receive first and second oscillating signals originating from the at least one signal. It is understood that the first and second transmitters are positioned on the mixer structure such that the first and second oscillating signals are neither fully in phase nor fully out of phase relative to one another. A computer is provided to perform the steps of obtaining calibration data associating one of two opposite directions of rotation of the drum with a reference phase difference; measuring a phase difference between the first and second oscillating signals; and determining that the drum rotates in one of the two opposite directions of rotation by comparing the measured phase difference to the reference phase difference.

Indeed, it was found that only one oscillating signal can allow to determine the rotational speed of the drum but that, however, it can be insufficient to determine the direction of rotation of the drum. Therefore, it was found convenient to suitably configure and position at least two transmitters on the rotating drum and on the mixer structure. The first and second transmitters can be used to receive at least two oscillating signals which are neither fully in phase nor fully out of phase relative to one another. The phase difference between these sinusoidal signals can help distinguish whether the drum rotates in one direction of rotation or in another direction of rotation, as will be described herebelow.

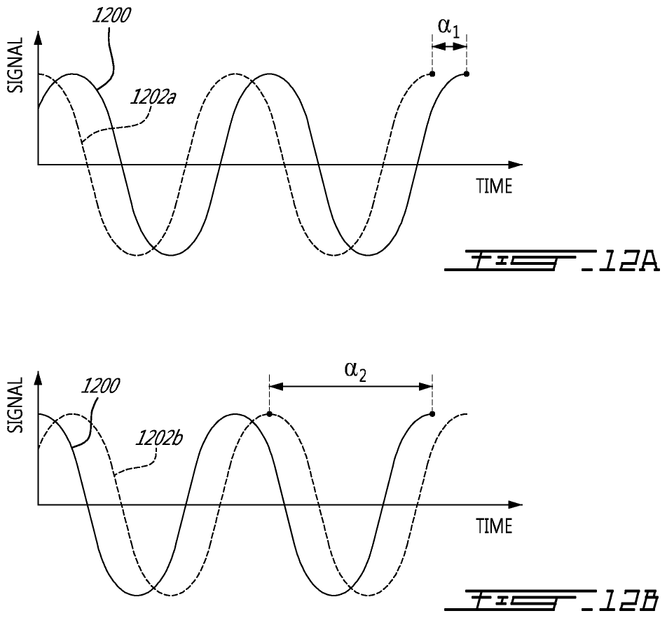

As it will be understood from FIGS. 12A and 12B, the calibration data can be indicative that the drum rotates in a first one of the two directions of rotation (e.g., clockwise) when the measured phase difference α1 is between 0° and 180° and that the drum rotates in a second one of the two directions of rotation when the measured phase difference α2 is between 180° and 360°, or vice versa. More specifically, FIG. 12A shows a first oscillating signal 1200 and a second oscillating signal 1202a. As it can be seen, the phase difference between the first and second oscillating signals 1200 and 1202a is α1. Accordingly, the computer, using the calibration data, can determine that the drum rotates in the first direction of rotation. However, with reference to FIG. 12B, the phase difference between the first and second oscillating signals 1200 and 1202b is α2. Accordingly, in this example, the computer can determine that the drum rotates in the second direction of rotation.

In some specific embodiments, the mixer structure is a mixer truck and the drum has a main axis inclined relative to the mixer truck. In these embodiments, the system can be provided with a sensor which is mounted to the rotating drum and which has a wired connection to the first transmitter. Accordingly, the sensor can transmit the first oscillating signal to the first transmitter such that the at least one signal transmitted by the one of the first and second transmitter includes the first oscillating signal. Also, the second oscillating signal can correspond to a strength of the first oscillating signal as received by the other one of the first and second transmitters. The one signal can thus include both the first and second oscillating signals. However, for the first and second oscillating signals to be neither fully in phase nor fully out of phase relative to one another, the physical position of each of the first and second transmitters is chosen carefully. Indeed, the second transmitter has to be provided away from a position which causes the first and second oscillating signals to be either fully in phase or fully out of phase relative to one another. For instance, in the embodiment illustrated in FIG. 8, an example of positioning of the first and second transmitters is provided. Specifically, the second transmitter is positioned away from the vertical axis which runs from circumferential positions 0° to 180°, and more specifically at circumferential position 135°. In this way, the first sinusoidal signal will have extremes at circumferential positions 90° and 270° and the second sinusoidal signal will have extremes at circumferential positions 135° and 315° thus leaving the first and second sinusoidal signals neither fully in phase nor fully out of phase. Other configurations of the first and second transmitters can be used. Different transmitter configurations can provide first and second sinusoidal signals which are neither fully in phase nor fully out of phase. For instance, the embodiments described with reference to FIGS. 8, 9, 10 and 11 may all provide two sinusoidal signals being neither fully in phase nor fully out of phase.

For instance, in embodiments where the drum is empty, the sensor can be a load sensor which has a cantilevered body inwardly projecting from an inner wall of the empty drum. Accordingly, the oscillating signal is a sinusoidal signal indicative of a gravitationally self-imparted force exerted on the load sensor as the empty drum rotates.

Alternatively, the sensor can be a light-intensity sensor located on an outer wall of the rotating drum such that the oscillating signal is indicative of an intensity of light shining on the light-intensity sensor as the drum rotates.

In some other embodiments, the system has a third transmitter mounted to the rotating drum at a circumferential position different from a circumferential position of the first transmitter.

In some of these embodiments, each of the first and third transmitters transmits a respective one of two electromagnetic signals each including a unique identifier. The second transmitter can receive the two electromagnetic signals from the first and third transmitters and recognize each one of the two electromagnetic signals based on the corresponding unique identifier. In this way, the first and second oscillating signals are indicative of a strength of a respective one of the two electromagnetic signals transmitted by the first and third transmitters and as received by the second transmitter as the first and third transmitters rotate with the rotating drum.

In some other of these embodiments, the second transmitter transmits one signal. As will be understood, each one of the first and third transmitters receives the one signal and the first and second oscillating signals are indicative of a strength of the one signal as received by each one of the first and third transmitters as the first and third transmitters rotate with the rotating drum.

Different embodiments of this system can be apparent for the skilled reader reading this disclosure. For instance, the first transmitter can transmit a signal for the second transmitter to receive a first oscillating signal while the second transmitter can transmit another signal for the first transmitter to receive a second oscillating signal. Alternatively, the third transmitter can be stationary relative to the mixer structure.

In a further aspect, there is provided a method of determining a direction of rotation of a drum rotatably mounted to a mixer structure. The method uses a first transmitter mounted to the rotating drum and a second transmitter being stationary relative to the mixer structure wherein the first and second transmitters are configured to establish a wireless. The method includes the steps of transmitting at least one signal over a wireless connection as the drum rotates, and receiving, over the wireless connection, first and second oscillating signals originating from the at least one signal, the first and second oscillating signals being neither fully in phase nor fully out of phase relative to one another. The method also includes the computer-implemented steps of obtaining calibration data associating one of two opposite directions of rotation of the drum with a reference phase difference; measuring a phase difference between the first and second oscillating signals; and determining that the drum rotates in one of the two opposite directions of rotation by comparing the measured phase difference to the reference phase difference.

As mentioned above, the computer can be configured to determine that the drum rotates in the one of the two directions of rotation when the measured phase difference is between 0° and 180° and to determine that the drum rotates in the other one of the two directions of rotation when the measured phase difference is between 180° and 360°.

In some embodiments, the step of measuring the phase difference includes a step of matching first and second oscillating functions on a previously received portion of the first and second oscillating signals, a step of calculating first and second phases of the first and second oscillating functions, and a step of calculating the phase difference by subtracting the first phase from the second phase.

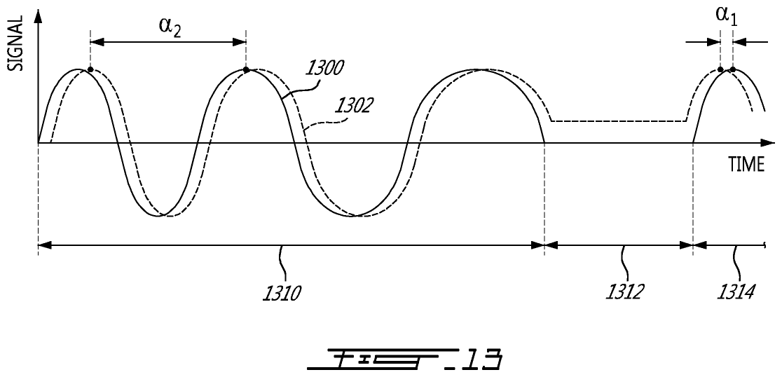

As it will be apparent from FIG. 13, the method can include a step of determining an angular position of the rotating drum at a given time and tracking the angular position of the rotating drum as a function of time based on the first and second oscillating signals. Similarly, the method can include a step of determining a direction of rotation of the rotating drum at a given time and tracking the direction of rotation of the rotating drum as function of time based on the first and second oscillating signals.

For instance, still referring to FIG. 13, the computer can determine that the drum is rotating in the second direction of rotation in the region 1310 since the phase difference between the first and second sinusoidal signals is α2. For instance, the computer can determine that the drum is not rotating at all in an inactivity region 1312 since the first and second sinusoidal signals are maintained at a constant value for a given time duration. Further, the computer can determine that the drum begins to rotate in the first direction of rotation in region 1314 since the phase difference has changed to α1. Accordingly, the computer can determine any change in the direction of rotation when the slope of the sinusoidal signal before the inactivity region 1312 is different from a slope of the sinusoidal signal after the inactivity region 1312. It will thus be understood that although the expression “oscillating signal” is meant to be construed as broadly as possible such as to encompass embodiments where the oscillating signal includes one or more oscillating portions and/or one or more constant portions.

As should be understood, the examples described above and illustrated are intended to be exemplary only. The scope of the claims should not be limited by the preferred embodiments set forth in the examples, but should be given the broadest interpretation consistent with the description as a whole.

1. A system for measuring a rotational speed of a drum rotatably mounted to a mixer structure and rotating relatively to the mixer structure, comprising:
a first transmitter mounted to the rotating drum and a second transmitter stationary relative to the mixer structure;
one of the first and second transmitters being configured for transmitting a signal over a wireless connection as the drum rotates;
the other one of the first and second transmitters being configured to receive an oscillating signal originating from the signal, the oscillating signal oscillating as the drum rotates such that the oscillating signal has a frequency indicative of the rotational speed of the rotating drum; and
a computer having a computer-readable memory having instructions stored thereon that, when executed by a processor, perform the steps of
measuring the frequency of the oscillating signal, and
outputting the frequency of the oscillating signal as the rotational speed of the rotating drum.

2. The system of claim 1 wherein the oscillating signal corresponds to a strength of the signal transmitted by the one of the first and second transmitters, the strength of the signal oscillating as function of a varying distance between the first and second transmitters as the drum rotates.

3. The system of claim 1 wherein the one of the first and second transmitters is configured to transmit the signal with a unique identifier of the one of the first and second transmitters, the other one of the first and second transmitters recognizing the oscillating signal as per the presence of the unique identifier in the signal.

4. The system of claim 1 further comprising a sensor mounted to the rotating drum and having a wired connection to the first transmitter, the sensor transmitting the oscillating signal to the first transmitter, and the signal transmitted by the one of the first and second transmitter being the oscillating signal.

5. The system of claim 4 wherein the mixer structure is a mixer truck and the rotating drum has a main axis inclined relative to the mixer truck, the sensor being a load sensor having a cantilevered body inwardly projecting from an inner wall of the rotating drum, the oscillating signal being indicative of a force exerted on the load sensor as the drum rotates.

6. The system of claim 5 wherein the rotating drum is empty, the oscillating signal being a sinusoidal signal indicative of a gravitationally self-imparted force exerted on the load sensor as the drum rotates.

7. The system of claim 4 wherein the sensor is a light-intensity sensor located on an outer wall of the rotating drum, the oscillating signal being indicative of an intensity of light shining on the light-intensity sensor as the drum rotates.

8. A method of measuring a rotational speed of a drum rotatably mounted to a mixer structure and rotating relatively to the mixer structure, using a first transmitter mounted to the rotating drum and a second transmitter being stationary relative to the mixer structure, the first and second transmitters being configured to establish a wireless connection, the method comprising:
one of the first and second transmitters transmitting a signal over the wireless connection as the drum rotates;
the other one of the first and second transmitters receiving, over the wireless connection, an oscillating signal originating from the signal, the oscillating signal oscillating as the drum rotates such that the oscillating signal has a frequency indicative of the rotational speed of the rotating drum; and
using a computer,
measuring the frequency of the oscillating signal, and
outputting the frequency of the oscillating signal as the rotational speed of the rotating drum.

9. The method of claim 8 wherein the oscillating signal corresponds to a strength of the signal transmitted by the one of the first and second transmitters, the strength of the signal oscillating as function of a varying distance between the first and second transmitters as the drum rotates.

10. The method of claim 8 further comprising generating the oscillating signal using a sensor mounted to the rotating drum and having a wired connection to the first transmitter and transmitting the oscillating signal to the first transmitter, the signal transmitted by the one of the first and second transmitter being the oscillating signal.

11. The method of claim 8 wherein the oscillating signal is a sinusoidal signal.

12. The method of claim 8 wherein said measuring includes matching an oscillating function on a previously received portion of the oscillating signal and associating a frequency of the oscillating function as the frequency of the oscillating signal.

13. The method of claim 8 wherein said measuring includes identifying at least two reference points in a previously received portion of the oscillating signal and calculating the frequency of the oscillating signal based on a time duration between the at least two reference points.

14. The method of claim 13 wherein the previously received portion of the oscillating signal includes at least a cycle of the oscillating signal, the at least two reference points being two successive extremes of the oscillating signal.

15. The method of claim 8 wherein said measuring includes differentiating a previously received portion of the oscillating signal and associating a frequency of the derivative of the previously received portion of the oscillating signal as the frequency of the oscillating signal.

16. The method of claim 8 further comprising obtaining at least one of an angular position and a direction of rotation of the rotating drum at a given time and tracking the at least one of the angular position and the direction of rotation of the rotating drum as function of time based on the oscillating signal.

17. A system for measuring a rotational speed of an empty drum rotatably mounted to a mixer truck, rotating relatively to the mixer truck and having a main axis inclined relative to the mixer truck, the system comprising:
a sensor mounted to the empty drum and generating a sinusoidal signal as the empty drum rotates; and
a computer having a computer-readable memory having instructions stored thereon that, when executed by a processor, perform the steps of
measuring the frequency of the sinusoidal signal, and
outputting the frequency of the sinusoidal signal as the rotational speed of the rotating drum.

18. The system of claim 17 wherein the sensor is a load sensor having a cantilevered body inwardly projecting from an inner wall of the empty drum, the sinusoidal signal being indicative of a gravitationally self-imparted force exerted on the load sensor as the empty drum rotates.

19. The system of claim 17 wherein the sensor is a light-intensity sensor located on an outer wall of the rotating drum, the oscillating signal being indicative of an intensity of light shining on the light-intensity sensor as the drum rotates.

20-31. (canceled)

32. The system of claim 1 further comprising obtaining at least one of an angular position and a direction of rotation of the rotating drum at a given time and tracking the at least one of the angular position and the direction of rotation of the rotating drum as function of time based on the oscillating signal.

33. The method of claim 17 further comprising obtaining at least one of an angular position and a direction of rotation of the rotating drum at a given time and tracking the at least one of the angular position and the direction of rotation of the rotating drum as function of time based on the sinusoidal signal.
